(19) United States
(12) Patent Application Publication
(10) Pub. No.: US 2008/0163352 A1
(43) Pub. Date: Jul. 3, 2008

(54) Method for loading a piece of software in a smart card, in particular applet

(75) Inventors: Alain Boudou, Vert (FR); Christoph Siegelin, Paris (FR); Pascal Urien, Villepreux (FR)

Correspondence Address: MILES & STOCKBRIDGE PC, 1751 PINNACLE DRIVE, SUITE 500, MCLEAN, VA, 22102-3833, US

(73) Assignee: CP8 Technologies, Paris (FR)

(21) Appl. No.: 12/000,766

(22) Filed: Dec. 17, 2007

Related U.S. Application Data
(62) Division of application No. 09/958,726, filed on Oct. 10, 2001.

(30) Foreign Application Priority Data
Feb. 10, 2000 (FR) 0001661

(51) Int. Cl. H04L 9/32

(52) U.S. Cl. 726/9

(57) ABSTRACT

The invention relates to the loading of an applet in a smart card (2a), with the aid of two loading programs, an in-loader (IL) stored in the card and an off-loader (OL), respectively. According to the invention, two specific communication protocol layers are provided, one in a terminal (1) that houses the card reader, and the other in the card. These layers include in particular intelligent agents that enable the card to offer a client/webserver and gateway or CGI function. The method includes at least one step during which an http request is sent to the card in order to address an HTML page, one step of retrieving parametrizing data carried by an HTML form, and one step of executing the second loading program (IL), by implementation of the CGI function, in order to load the applet.

The invention relates to a method for loading a piece of software into a smart card.

More particularly, it applies to loading a piece of software known as an “applet”. This involves an application written in JAVA language (registered trademark). These applications, which in general are not very voluminous, are independent of the architectures of the systems in which they are implanted. Accordingly, they can run on any information processing system, as long as the system employs the concept known as “JAVA Virtual Machine”. An application written in JAVA language is in general translated into an intermediate language known as byte code. The aforementioned JAVA Virtual Machine constitutes an interpreter of this byte code, in such a way as to be executed directly in target system that is the host of said virtual machine.

In general, the system architectures on which such applications run are of the type known as a client-server. In this case, the term “servlet” is also used for an application stored on a server system, and “applet” is used for an application stored on a client system. Below, the term “applet” will be used generally.

Pieces of software in the form of applets, as has just been recalled, can be stored in a nonvolatile memory on a smart card, in the same way as any other application, as long as the quantity of code is not overly voluminous.

The method according to the invention more particularly relates to a terminal or user station provided with a smart card reader.

Within the scope of the invention, the term “terminal” must be understood in a general sense. The aforementioned terminal can in particular comprise a personal computer operating under various operating systems, such as Windows or UNIX (both of which are registered trademarks). It can also comprise a work station, a portable computer, or a dedicated card terminal.

In the current state of the art, loading an applet on a smart card (also called teleloading) is done thanks to two specific programs. These programs are generally known by the terms off-loader for the first one and in-loader for the second. The off-loader program is executed in the terminal, and the in-loader program is executed in the smart card. The loading programs off-loader and in-loader communicate with one another through a link standardized under ISO 7816-3, which is a protocol universally reserved for communications between a smart card and its host terminal. This protocol employs a set of exchanges, which are generally proprietary (commands of a type known as APDU, which will be explained hereinafter) in order to accomplish the loading of an applet.

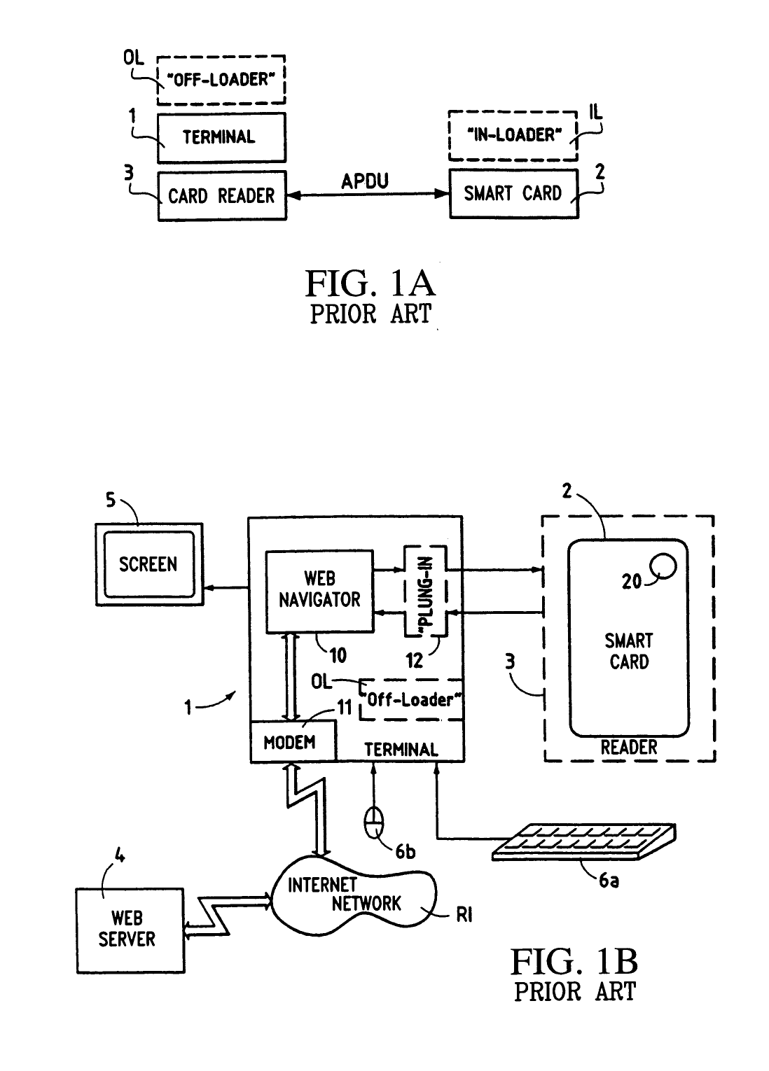

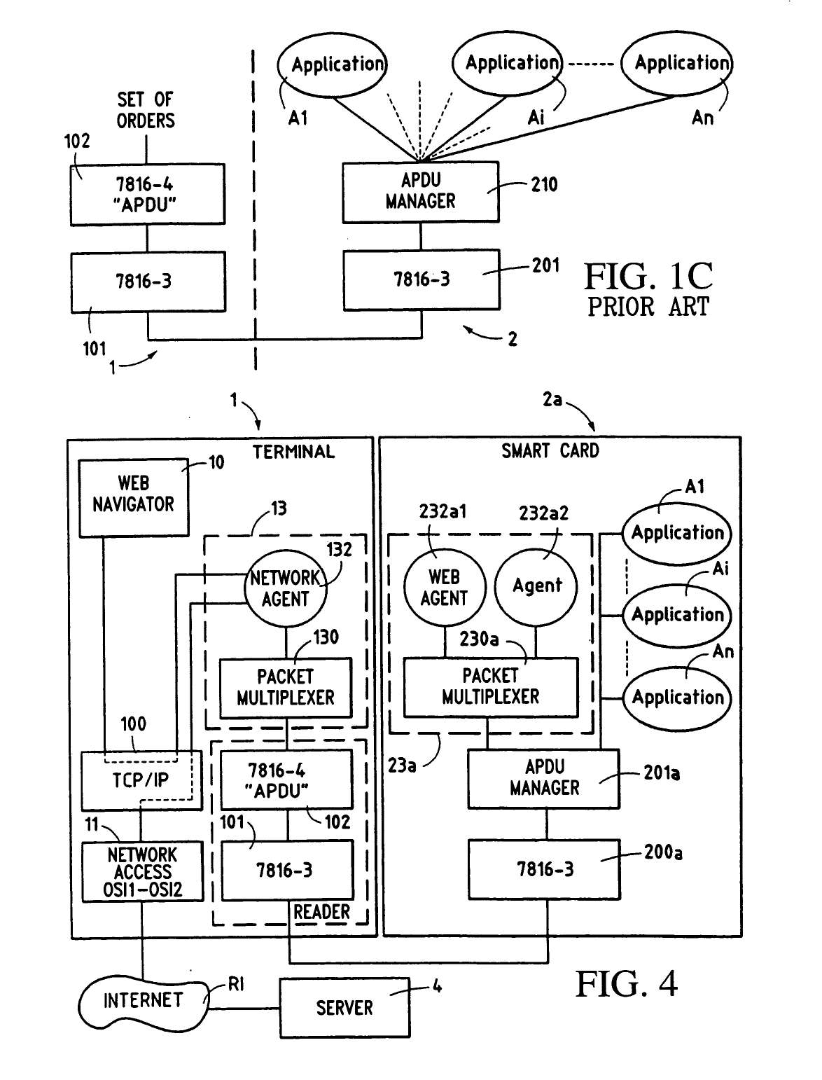

FIG. 1A appended to the present description schematically illustrates the architecture employed for loading applets into a smart card, in accordance with the prior art.

The terminal 1 stores a first specific loading program (off-loader) OL. It communicates with a smart card 2 via a smart card reader 3. The transmissions are done by a standardized communication protocol making use of aforementioned commands, and this protocol will be described in detail hereinafter.

The smart card 2 for its part stores a second specific loading program (in-loader) IL.

A first disadvantage of this method is that the programs IL and OL must be matched so that they can communicate with one another. It follows that if they are of different origins, they are a priori incompatible. This characteristic is linked with the set of commands to be used.

A second disadvantage is due to the fact that communications are done by the aforementioned protocol ISO 7816. This protocol requires physical proximity between the programs OL and IL. It follows that the program OL must generally be executed directly in the terminal 1, and not in another terminal or a remote server, for example.

Given the spectacular development of the internet, an ever-increasing number of terminals are connected to this network, especially so as to be capable of linkage with remote web-type servers. It would accordingly be valuable for instance to be able to store the off-loader part OL of the applet loading program in a webserver connected to this network. The applets to be loaded on one or more smart cards can also be stored in this server or in a plurality of other servers of this type.

In the state of the art, this mode of operation meets with a dual impossibility. The first has already been mentioned: The standard reserved for communications between the terminal and the smart card a priori imposes physical proximity between the locations of the off-loader and in-loader programs OL and IL, respectively.

Second, the transmissions between two systems, such as a terminal and remote server, via the internet makes use of internet-type protocols. In the state of the art, it is not possible to achieve direct communications between a smart card and the internet, as will also be explained.

Within the scope of the invention, the term “internet network” or internet includes not only the internet per se but private business networks or the like of the type known as “intranet” and networks that extend them to the outside, of the type known as “extranet”, and in general any network in which data exchanges are done by a protocol of the internet type. Below, such a network will be referred to generically as an internet network, or simply “internet”.

First, the general architecture of a smart card-based applications system will be reviewed briefly, with reference to FIGS. 1B and 1C.

A smart card-based applications system can generally include the following main elements:
a smart card;
a host system comprising the aforementioned terminal;
a communications network, that is, the internet in the preferred application;
and an applications server connected to the internet.

FIG. 1B schematically illustrates one example of this type of architecture. The terminal 1, such as an individual computer, includes a reader 3 for a smart card 2. This reader 3 may or may not be physically integrated with the terminal 1. The smart card 2 includes an integrated circuit 20 whose input/output connections are flush with the surface of its substrate, to allow a supply of electrical energy and communications with the terminal 1. This terminal includes circuits 11 for access to the internet RI. These circuits can be constituted by a modem for connection to a switched telephone line or a higher-speed communication path, such as the Integrated Service Digital Network (ISDN), cable, or satellite links. The circuits 11 enable connection to the internet RI, either directly or via an internet service provider (ISP). Recourse can also be had to an intermediate system such as a proxy or an insulation system known as a firewall (or guard barrier).

The terminal 1 naturally includes all the circuits and devices necessary for its proper functioning, which have not been shown for the sake of simplifying the drawing: a CPU, random access and read-only memories, magnetic disk mass memory, disk drive and/or CD-ROM drive, and so forth.

Typically, the terminal 1 is also connected to conventional peripherals, either integrated or not, such as a display screen 5, a keyboard 6a and a mouse 6b, and so forth.

The terminal 1 can be put into communication with servers or any information processing systems connected to the network RI, of which a single server 4 is shown in FIG. 1A. The access circuits 11 put the terminal 1 into communication with the servers 4 using a particular software 10, called a web navigator or browser. This enables access to various applications or data files that are distributed over the entire network RI, generally by a client-server mode, and in particular enables access to multimedia files.

Typically, communications over the networks are done in accordance with protocols that meet standards including a plurality of superimposed software layers. In the case of an internet-type network RI, the communications are done according to protocols specific to this type of communications, which will be described in detail hereinafter, but which also include a plurality of software layers. The communication protocol is selected as a function of the particular application contemplated, such as looking up web pages, transferring files, electronic mail (or e-mail), forms, news, etc.

The software architecture of the system including a terminal, a smart card reader and a smart card, is shown schematically in FIG. 1B. It is described by ISO standard 7816, which in turn includes several subsets:
ISO 7816-1 and 7816-2, pertaining to the dimensions and marking of cards;
ISO 7816-3, pertaining to the transfer of data between the terminal and the smart card; and
ISO 7816-4, pertaining to the structure of the set of orders and the format of commands.

In FIG. 1B, for terminal 1, only the layers meeting ISO standard 7816-3, identified by reference numeral 101, and an APDU order manager (ISO 7816-4), reference numeral 102 are shown. For the smart card 2, the layers meeting ISO 7816-3 are identified by reference numeral 200, and the ADPU order manager (ISO 7816-4) has reference numeral 201. The applications carry reference symbols Aₗ, . . . Aᵢ, . . . Aₙ, where n is the maximum number of applications present in the smart card 2.

An application Aᵢ in the smart card 2 (FIG. 1A) conducts a dialog with the terminal 1 by means of a set of orders. This set typically has writing and reading orders. The order format is known by the abbreviation APDU (“Application Protocol Data Unit”). It is defined by the aforementioned ISO standard 7816-4. A command APDU is written as “APDU.command”, and a response APDU is written “APDU.response”. The APDUs are exchanged between the card reader and the smart card by means of a protocol specified by the aforementioned ISO standard 7816-3 (for example, in the character mode: T=0; or in the block mode: T=1).

When the smart card 2 includes a plurality of distinct applications, as illustrated by FIG. 1C, it is called a multi-application card. However, the terminal 1 is in a dialog with only one application at a time. An application Aᵢ is present for example in the form of an “applet”, which can recorded initially, or loaded from the terminal 1. To do so, as shown in FIG. 1A, an off-loader program OL, recorded in the terminal 1, and an in-loader program IL, which forms one of the applications Aᵢ of the smart card 2, can be used.

The selection of a particular application Aᵢ is obtained with the aid of an APDU of the selection type (“SELECT”). Once this choice has been made, the APDUs that follow are routed through this application. A new “APDU SELECT” causes the current application to be abandoned so that another one is then chosen. The software manager subset of the APDUs 201 makes it possible to choose a particular application Aᵢ in the smart card 2, to memorize the application thus chosen, and to transmit and/or receive APDUs to and from this application.

To summarize what has just been described, the selection of an application Aᵢ and dialog with it are done by exchanges of APDU orders. Let it be assumed that the applications Aᵢ are conventional applications, hereinafter called GCAs (for Generic Card Application).

This mode of operation requires that the programs OL and IL be matched, so that the APDU orders exchanged can be compatible and understood by these two applications.

Given the above review, it should be noted that the smart card 2 cannot communicate directly with standard commercial navigators except by modifying their code.

Furthermore and above all, current smart cards, which moreover meet the standards described above, have a hardware and software configuration that no longer allows them to communicate directly with the internet. In particular, they cannot receive and transmit data packets by one or the other of the protocols used in this type of network. Hence it is necessary to provide an additional piece of software, implanted in the terminal 1, generally in the form known as a “plug-in”. This piece of software, which is identified by reference numeral 12 in FIG. 1B, acts as the interface between the navigator 10 and the card 2, and more specifically the electronic circuits 20 in this card 2.

In a first characteristic of the invention, the two loading programs OL and IL are no longer dependent on one another. In other words, they no longer have to be matched to be compatible.

In a second characteristic of the invention, the OL portion of the loading programs no longer has to be necessarily stored in the terminal, that is, in physical proximity with the second portion IL. On the contrary, the program OL can be stored in a remote server connected to the terminal via a network of the internet type.

To do so, and in a first characteristic of the invention, the smart card behaves like a web-type server-client with regard to the terminal with which it is associated.

To attain this object, a specific communication protocol layer is provided in the smart card and its counterpart in the terminal. The term “specific” must be understood to mean specific to the method of the invention. In fact, these communication layers, called specific communication layers, are non-specialized, regardless of the application in question. They act only in the process of bidirectional data exchanges between the smart card and the terminal on the one hand, and the smart card and the network, on the other.

The specific communication software layer, known as “intelligent agents”, make it possible in particular to convert protocols. The intelligent agents will hereinafter be called simply “agents”. There are matched agents in the specific communication layers assigned to the terminal and the smart card, respectively. By the method of the invention, sessions between matched agents are established.

In another characteristic, the method of the invention makes it possible to activate applications of a conventional type, that is, of the aforementioned CGA type, that are located in a smart card without having to modify them in any way.

To do so, one or more particular intelligent agents called script translators are provided, which receive requests from a navigator and translate them into APDU orders that can be understood by the CGA application. In this way, a function similar to that also known as “CGI” in conventional webservers is implanted into the smart card. This function makes it possible to implement an application in the smart card using an internet protocol of the HTTP type.

Loading an applet in the smart card can be done by this CGI, or Common Gateway Interface. The portion IL of the loading program is considered to be a command script, which will be called “cgi-script”, attached to the webserver function offered by the smart card. These exchanges between the programs OL and IL can take place with the aid of conventional forms in HTML.

While preserving the aforementioned ISO standards for communications between the terminal and the smart card via the smart card reader, the method according to the invention enables exchanges between the portions of loading programs OL and IL by using the internet communication protocol TCP/IP, and the portion OL and the applets to be loaded can be stored locally or in a remote server.

Hence the main subject of the invention is a method for loading a piece of software into a smart card from a terminal connected to said smart card by way of a smart card reader enabling communications by a first predetermined protocol, said loading being effected by the implementation and cooperation of first and second loading programs, said second loading program being stored in said smart card, characterized in that it includes at least the following phases:

a) a first preliminary phase, consisting of implanting, in said smart card, a first piece of software, forming a specific communication protocol layer;

b) a second preliminary phase, consisting of implanting, in said terminal, a second piece of software, forming a specific communication protocol layer;
that said first and second pieces of software further include at least one pair of first matched autonomous software entities, each of said entities cooperating with one another in such a way as to enable the establishment of a session of bidirectional data exchanges between at least said terminal and said smart card, in such a manner that said smart card offers the function of a client/webserver;
that it includes a third preliminary phase, consisting of implanting in said smart card at least one second software entity capable of interpreting a set of instructions and translating it into a set of orders, in such a way as to cooperate with said second specific piece of software so that said smart card offers a gateway interface function CGI, said smart card including at least one of said sets of instructions associated with said loading program;
and that it includes at least the following steps:

1) opening a first data exchange session between at least said terminal and said smart card, for the transmission

of a request so that said first loading program will retrieve loading parametrizing data furnished by said second loading program;

2) opening a second data exchange session between said smart card and at least said terminal, to transmit said loading parametrizing data to said first loading program, said parametrizing data including a reference to said instructions that are associated with said second loading program; and

3) opening a second data exchange session between said smart card and at least said terminal, and for submitting a loading file taking said loading parametrizing data into account, said file including data associated with said piece of software to be loaded; interpretation of said set of instructions associated with said second loading program, by implementation of said CGI function, in such a way as to generate a set of orders transmitted to said second loading program to execute this program and obtain said unloading of said piece of software.

The invention will now be described in more detail in conjunction with the accompanying drawings, in which:

FIG. 1A schematically illustrates one exemplary embodiment of an architecture enabling the loading of an applet in a smart card, according to the prior art;

FIGS. 1B and 1C illustrate the hardware and software architectures, respectively, of a smart card-based application system connected to an internet network, according to the prior art;

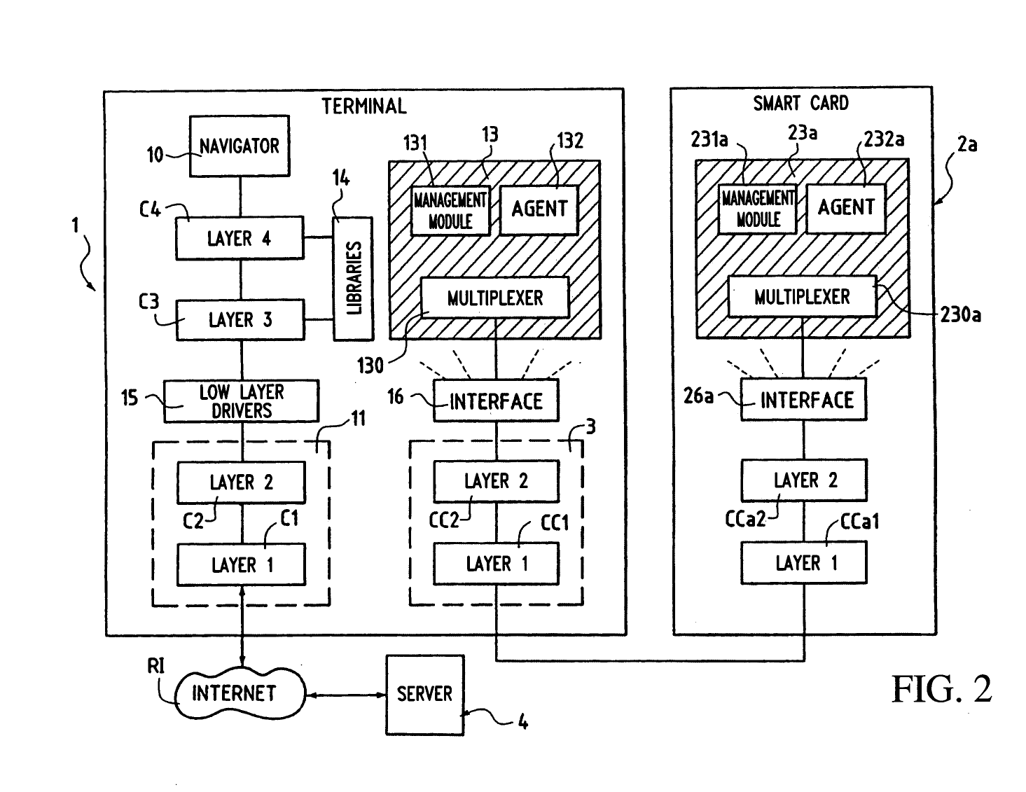

FIG. 2 schematically illustrates one example of a smart card-based applications system according to the invention, the smart card acting as a webserver;

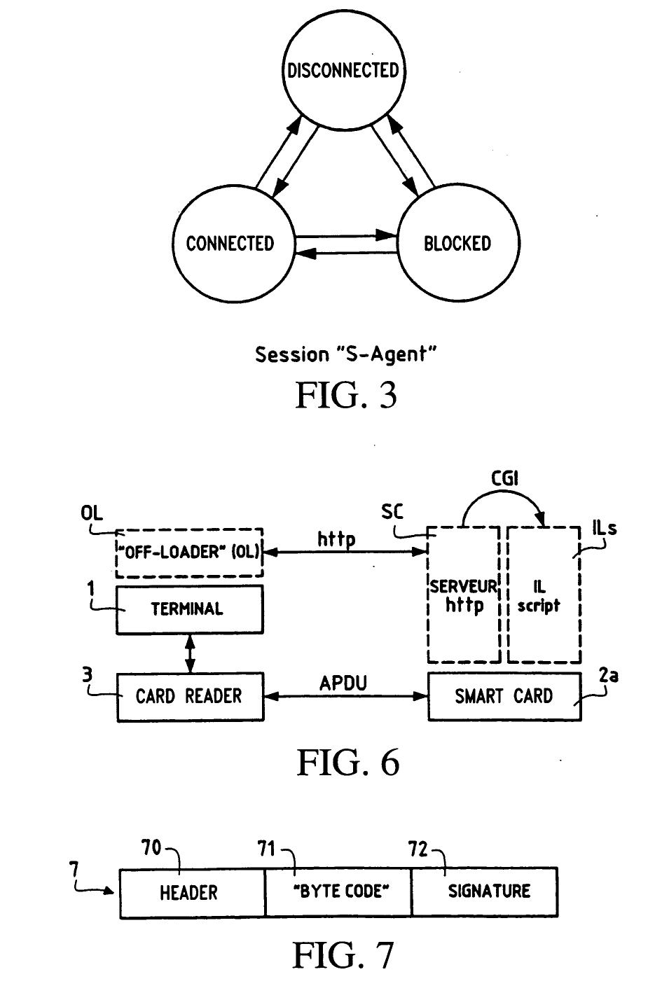

FIG. 3 is a diagram showing states of a session between software entities known as intelligent agents, in one feature of the invention;

FIG. 4, in simplified fashion, illustrates the software architecture of a system according to the invention in which the smart card includes intelligent agents;

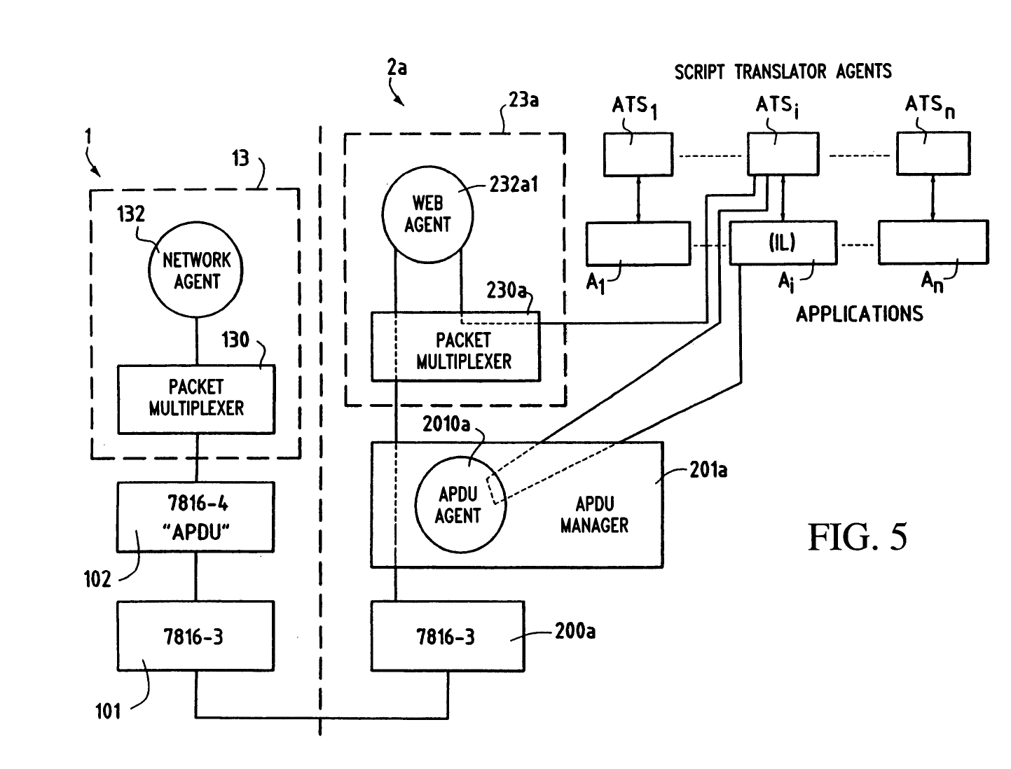

FIG. 5 in simplified fashion illustrates the logical architecture of a system according to the invention, in which the smart card includes intelligent script translator agents;

FIG. 6 schematically illustrates an exemplary embodiment of an architecture enabling the loading of an applet into a smart card according to the invention;

FIG. 7 illustrates the structure of a file for loading an applet that can be used by the method of the invention;

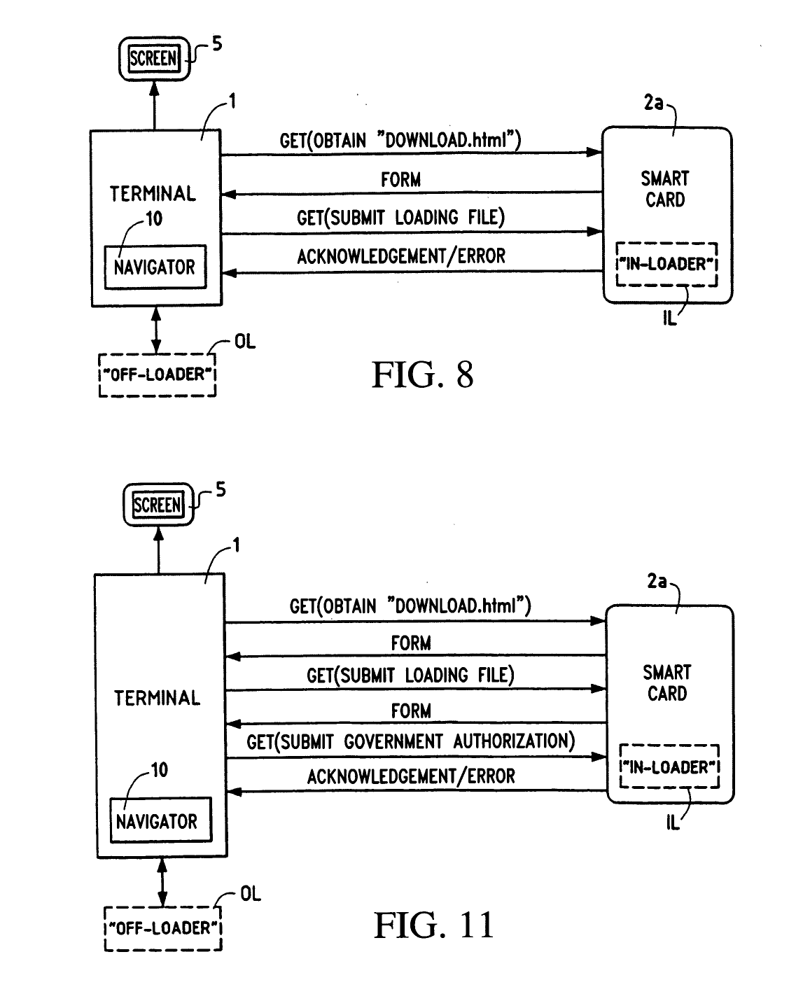

FIG. 8 schematically illustrates the principle phases of the method for loading an applet in a smart card, in a first practical exemplary embodiment;

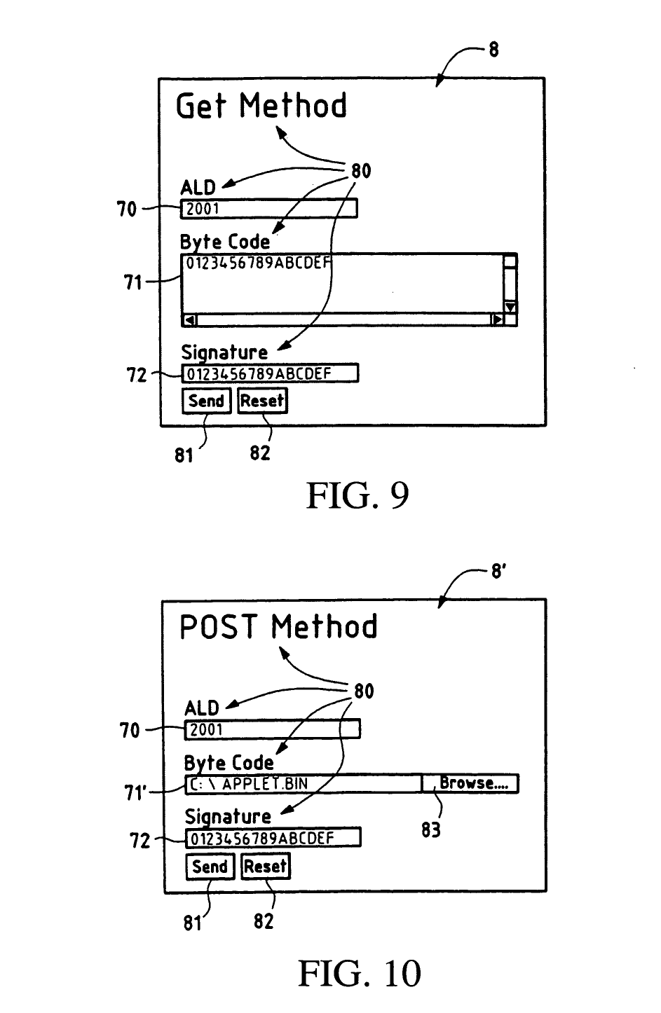

FIG. 9 schematically illustrates the principle phases of the method for loading an applet in a smart card, in a second practical exemplary embodiment;

FIGS. 9 and 10 illustrate two examples of forms in HTML language that can be used by the method for loading an applet in a smart card according to the invention, for the implementation of methods known as “GET” and “POST”, respectively; and

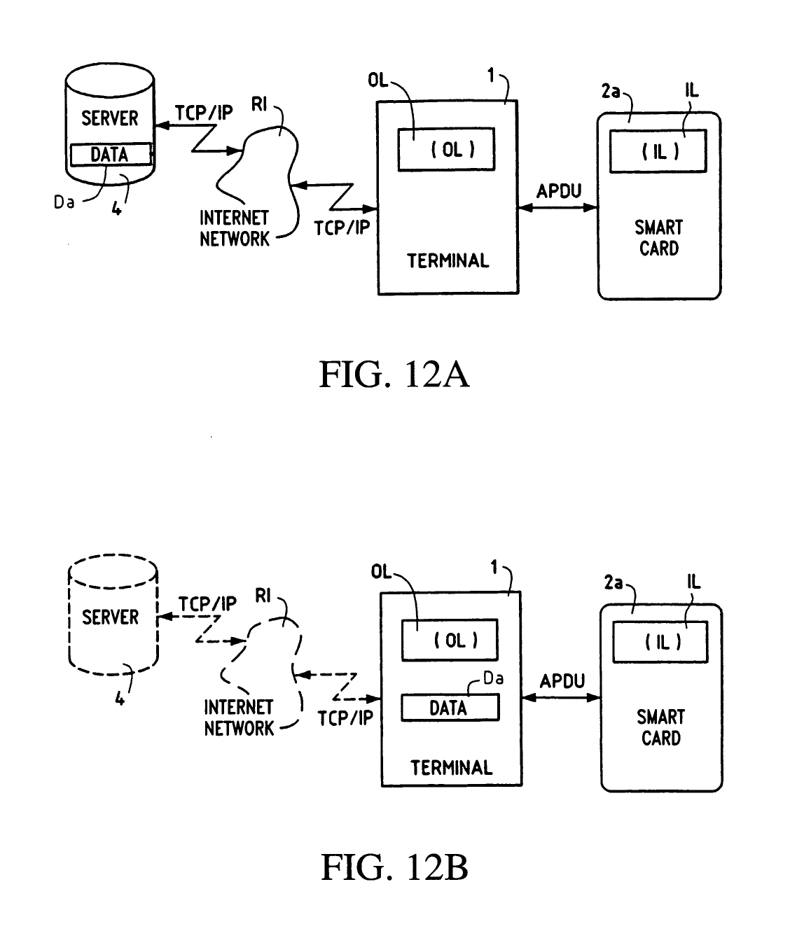

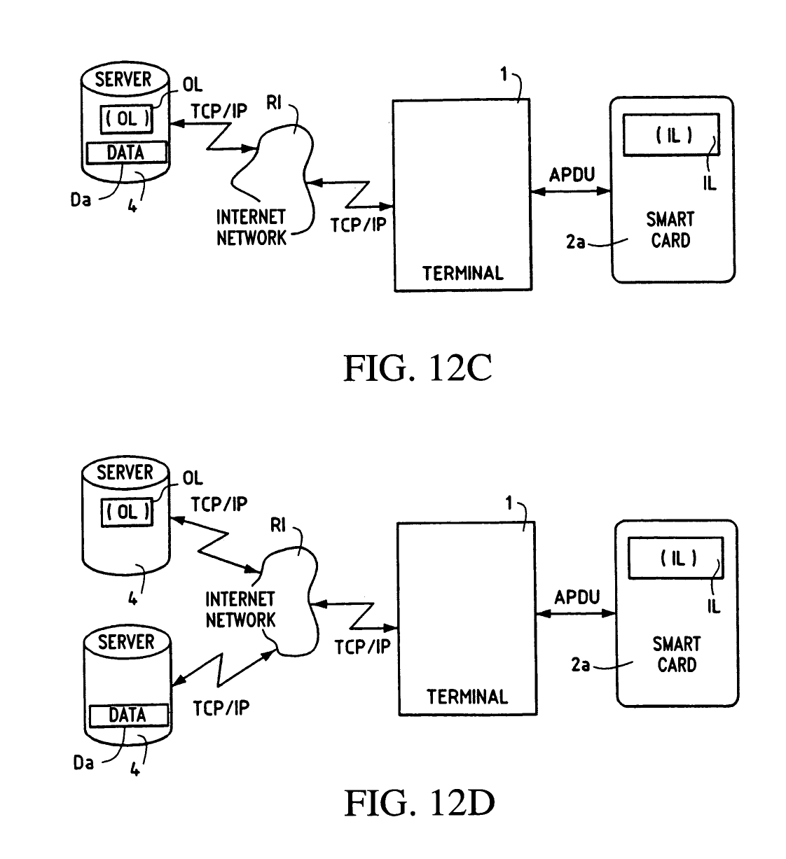

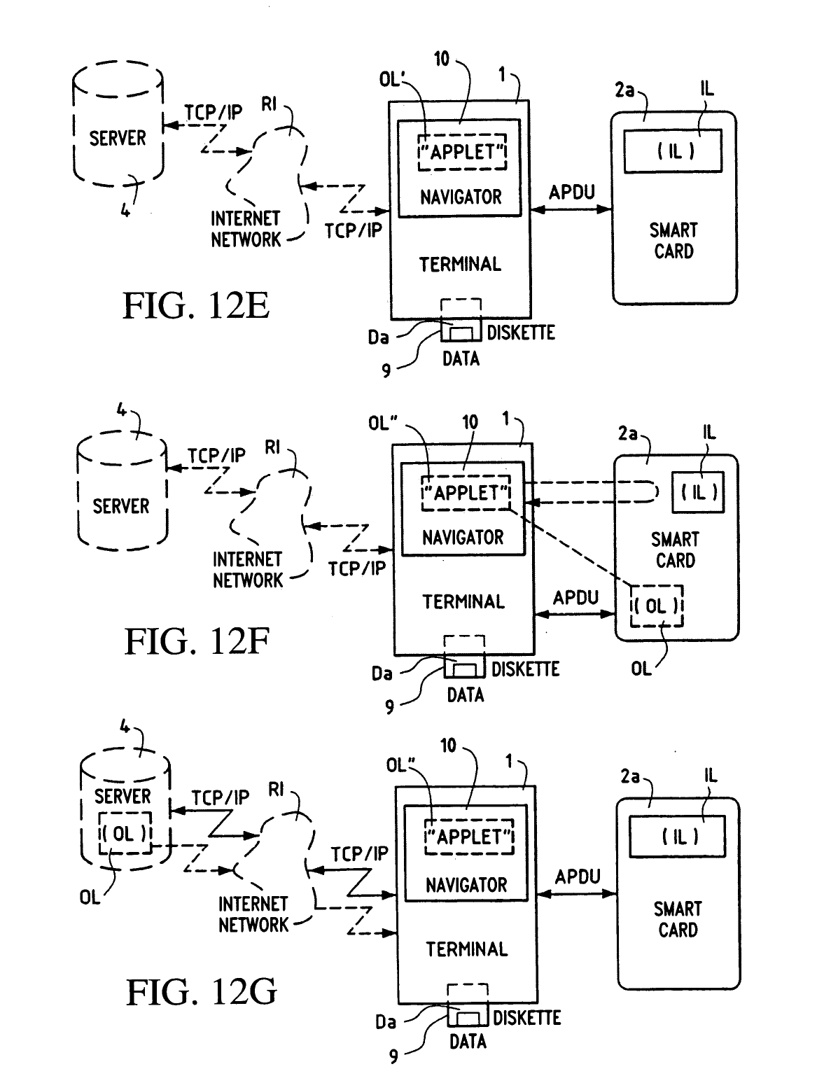

FIGS. 12A-12G illustrate several variant embodiments of system architectures that enable loading an applet into a smart card according to the invention.

In the following description, without in any way limiting the scope, the discussion will refer to the preferred application of the invention, unless otherwise noted; that is, it refers to the case of a terminal connected to one or more remote servers via the internet.

Before the method of activating applications located in a smart card according to the invention is described and an architecture for implementing it is described in detail with reference to FIG. 2, it is appropriate first to review briefly the main characteristics of communication protocols in these networks.

The architecture of communication networks is described by various layers. By way of example, the OSI standard (for Open System Interconnection) defined by the ISO includes seven layers, which range from what are known as lower layers (such as the “physical” layer, which involves the physical transmission substrate) to what are known as high, or upper, layers (such as the “application” layer), passing through intermediate layers, especially the “transport” layer. A given layer offers its services to the layer that is immediately above it, and requests other services, via suitable interfaces, from the layer that is immediately below it. The layers communicate with the aid of primitives. They can also communicate with layers of the same level. In certain architectures, various layers may not be present.

In an environment of the internet type, the layers are five in number, and more precisely, ranging from the highest to the lowest layer, they are: the application layer (“http”, “ftp”, “e-mail”, etc.), the transport layer (“TCP”), the network addressing layer (“IP”), the data link layer (“PPP”, “Slip”, etc.), and the physical layer.

Turning to FIG. 2, with the exception of specific communication protocol software layers 13 and 23a, implanted in the terminal 1 and the smart card 2a, respectively, the other hardware or software elements are common to the prior art, and there is no need to describe them again here in detail.

The terminal 1 includes circuits 11 for access to the network RI, the circuits being constituted by a modem, for example. These circuits include the lower software layers C₁ and C₂, which correspond to the physical and data link layers.

Also shown are the upper layers C₃ and C₄, which correspond to the network addressing (IP, in the case of the internet) and transport (TCP) layers. The upper application layer (“http”, “ftp”, “e-mail”, etc.) has not been shown.

The interface between the lower layers C₁ and C₂ and the upper layers C₃ and C₄ is made up of a software layer, generally called a “low driver layer”. The upper layers C₃ and C₄ rest on this interface and are implemented by way of specific function libraries or network libraries 14, with which they correspond. In the case of the internet, TCP/IP is implemented by means of what are known as “socket” libraries.

This organization enables a navigator 10 to make requests of a server 4 to consult web pages (“HTTP” protocol) to transport files (“FTP” protocol) or to send electronic mail (“e-mail” protocol), in an entirely classical fashion.

The terminal 1 also includes a card reader 3, which may or may not be integrated. For communication with the smart card 2a, the card reader 3 also includes two low layers CC₁ (physical layer) and CC₂ (data link layer), which play a role similar to the layers C₁ and C₂. The software interfaces with the layers CC₁ and CC₂ are described for example by the PC/SC specification (part 6, service provider). The layers themselves, CC₁ and CC₂, are described in particular by ISO

standards 7816-1 through 7816-4, as has been noted above.

An additional software layer 16 forms an interface between the application layers (not shown) and the lower layers CC₁ and CC₂. The main function assigned to this layer 16 is that of multiplexing/demultiplexing.

Communications with the smart card 2a are done by a paradigm similar to that used to manipulate files in an operating system of the UNIX type (UNIX is a registered trademark): OPEN, READ, WRITE, CLOSE, etc.

A similar organization is found in the smart card 2a, that is, the presence of two low layers, CCa₁ (physical layer) and CCa₂ (data link layer), as well as an interface layer 26a, which is entirely similar to the layer 16.

In a first characteristic of the invention, two specific protocol layers 13 and 23a, respectively, are provided on one hand and other, that is, in the terminal and in the smart card 2a.

In the terminal 1, the specific layer 13 interfaces with “low driver layers” 15, libraries 14 of network layers C₃ and C₄, and protocol layers for the card reader 3, that is, the lower layers CC₁ and CC₂, via the multiplexing layer 16. The specific layer 13 enables the transfer of network packets from and to the smart card 2a. It also adapts the existing applications, such as the internet navigator 10, e-mail, etc., for uses that employ the smart card 2a.

In the smart card 2a, quite a similar organization is found, with an additional instance of the specific layer 23a, which is the counterpart of the layer 13.

More precisely, the specific layers 13 and 23a are subdivided into three main software elements:
a module 130 or 130a for transferring blocks of information between the layers 13 and 23a, via the
   conventional layers CC₁, CC₂, CCa₁, and CCa₂;
one or more pieces of software, called intelligent agents, 132 or 232a, which by way of example embody protocol conversion functions;
and a specific configuration management module 131 and 231a, respectively, which module can be likened to a particular intelligent agent.

For the sake of simplicity, these intelligent agents will be called simply agents hereinafter, as noted above.

In the terminal 1 and the smart card 2a, a communication protocol stack is found between the two entities.

The layers at level two (data link layers) CC₂ and CCa₂ assure the exchange between the smart card 2a and the terminal 1. These layers are responsible for detecting and as needed correcting transmission errors. Various protocols can be used, and by way of a non-exhaustive example, the following:
the recommendation ETSI GSM 11.1;
the protocol defined by ISO 7816-3, in character mode T=0;
the protocol defined by ISO 7816-3, in block mode T=1;
or the protocol defined by ISO standard 3309, in HDLC (High-level Data Link Control procedure) frame mode.

Within the scope of the invention, the ISO 7816-3 protocol in block mode will preferably be used.

In a manner known per se, a certain number of primitives is assigned to each protocol layer; they enable the exchanges of data between layers of the same level and from one layer to the other. By way of example, the primitives assigned to the level 2 layer are of the “data request” (“Data.request”) and “send data” (“Data.response”) by the card as well as “confirmation of data” (“Data.confirm”), etc.

More specifically, the layers 13 and 23a are tasked with dialog between the smart card 2a and the host, that is, the terminal 1. These layers enable the exchange of information between a user (not shown) of the terminal 1 and the smart card 2a, for example by way of scrolling menus in the form of hypertext in the HTML format. They also allow the installation of a configuration adapted for the transmission and/or reception of data packets.

As indicated above, the layers include three distinct entities.

The first layer 130 or 230a essentially comprises a software multiplexer. It enables the exchange of information between the smart card 2a and the host terminal 1, in the form of protocol data units. It plays a role similar to that of a data packet switcher. These units are sent or received via the layer at level 2 (data link layer). This particular communication protocol makes it possible to put at least one pair of agents into communication. The first agent of each pair, 132, is located in the layer 13 of the terminal 1, while the second agent, 232a, is located in the layer 23a in the smart card 2a. A link between two agents is associated with a session that will be called “S-Agent”. A session is a bidirectional data exchange between these two agents. If one or the other of the layers 13 and 23a includes a plurality of agents, then the agents of the same layer can also establish sessions between them and/or with the modules 131 and 231a that constitute the particular agents.

More precisely, an agent is an autonomous software entity, which can embody all or some of the functions of layers at levels 3 and 4, depending on the configuration implemented by the terminal 1.

These agents are assigned particular properties or attributes. To define the concepts, and by way of non-limiting examples, the following six properties are assigned to the agents:
“host”: agent located in the terminal;
“card”: agent located in the smart card;
“local”: agent not communicating with the network;
“network”: agent communicating with the network (in the terminal);
“client”: agent which initializes a session;
“server”: agent which receives a session request.

A particular agent is identified by a reference, such as a 16-bit integer (that is, an integer between zero and 65535). The most significant bit (b15=1) tells whether this reference is local (local communications with the smart card or the terminal) or remote (b15=0).

Two large categories of agents exist: the agents of the “server” type, which are identified by a fixed reference, and the agents of the “client” type, which are identified by a variable reference that can also be called ephemeral, issued by the configuration management module 131 or 231a.

The agents communicate with one another by way of entities called protocol data units or pdus, which include a target reference and a source reference. This particular pdu can also be called a “SmartTP pdu”, with reference to the currently used term “smart card”. In particular, the pdus utilize the references defined above.

A SmartTP pdu, or more simply pdu hereinafter, includes a source reference, a target reference, a set of bits comprising flags, which specify the nature of the pdu, and optional data:
the “OPEN” flag is in place to indicate the opening of a session;
the “CLOSE” flag indicates the closure of a session; and
the “BLOCK” flag indicates that the agent is waiting for a response from its correspondent and has suspended all activity.

A pdu that does not include data will be called a token.

The SmartTP entity controls the existence of the target agent and performs the commutation of a packet to it.

An agent session or “S-Agent” has three notable states, specifically:
a disconnected state: no session is open with any other agent;
a connected state: a session is open with another agent, an “S-Agent” session being identified by a pair of references; and
a blocked state, where the agent is connected and is waiting for a response from its correspondent.

The mechanism for establishing an “S-Agent” session is as follows:
a new instance of a client agent is created (in the smart card or the terminal), this agent being identified by a pseudo-unique ephemeral reference;
the client agent sends a pdu to a server agent (whose reference is furthermore known) with the “OPEN” flag in place, and the client agent shifts to the connected state or the blocked state, depending on the value of the “BLOCK” flag; and
the server agent receives the pdu with the “OPEN”
   flag and shifts to the connected state.

Once a session is open, two agents exchange data via pdus.

The mechanism for closing a session is as follows:
one agent sends a pdu with the “CLOSE” flag in place (which may possibly include data); and
the other agent receives a pdu with the “CLOSE” flag in place (which may possible include data), and the “S-Agent” session shifts to the disconnected state.

FIG. 3 schematically illustrates the diagram of states of “S-Agent” sessions, such as have just been described.

The layers 130 and 230a manage tables (not shown) that contain the list of agents present, in the host terminal 1 and the smart card 2a.

In practical terms, the agents enable an exchange of data (in hypertext, for example), but also enable launching network transactions, authorizing communications between the smart card 2a and a remote server 4 (FIG. 2).

The configuration management modules, 131 and 231a, respectively, are similar to particular agents. For example, the module 131 in the host terminal 1 in particular manages information relating to the configuration of this terminal (modes of operation), lists other agents present, and so forth. The module 231a in the smart card 2a has analogous functions. These two agents can be put into communication with one another in order to establish a session.

In practical terms, the smart card 2a is advantageously “addressed” by using a URL (for universal resource locator) that defines a feedback to the terminal 1 itself, rather than pointing to an external server. By way of example, the structure of this URL is typically as follows:

http://127.0.0.1:8080 (1)

in which 127.0.0.1 is the feedback IP address, and 8080 is the port number.

FIG. 4 in simplified fashion shows the software architecture of a system according to the invention, of the type shown in FIG. 2 but now shown in more detail. The smart card 2a includes a plurality of agents, only two of which are shown: an agent 232a₁ of a type that is not precisely defined, and an agent 232a₂, of the web type. The software stack includes the lower protocol layers 200a, which meet ISO standards 7816-3 (FIG. 2: CCa₁ and CCa₂), the APDU command manager 201a₁, and the packet multiplexer 230a, this latter being interfaced with the agents, in particular the web agent 231a₁.

There are two stacks in the terminal, one communicating with the internet RI and the other with the smart card 2a. The first stack includes the devices 11 (FIG. 2: C₁ and C₂) for access to the network (standards OSI 1 and 2), and the TCP/IP protocol layers (FIG. 2: C₃ and C₄), reference numeral 100. These third layers are interfaced with the web navigator 10. The other stack includes the lower protocol layers 101, which meet ISO standards 7816-3 (FIG. 2: C₁ and C₂), the APDU order manager 102, and the packet multiplexer 130, this last being interfaced with agents, only one of which, 132, is shown. Assuming that this agent is of the network type, it can furthermore communicate on the one hand the navigator 10, via the TCP/IP layers 100, and on the other with the internet RI, via these same TCP/IP layers 100 and the device 11 for access to the network RI.

The APDU order manager 201a is also interfaced with one or more applications-level layers, which will simply be called applications. As has been noted, these applications Aₗ . . . , Aᵢ . . . , Aₙ, are application of a conventional type.

In summary, the client/webserver furnished by the smart card 2a can be embodied by association with the web agent 231a₁ in the smart card and the network agent 132 in the terminal 1, and by implementing sessions between agents, as has been described.

The smart card 2a does indeed have the function of client/webserver. In addition, in a characteristic of the method of the invention, any conventional application Aₗ through Aₙ of the GCA type mentioned above can be activated through this client/webserver, either via the web navigator 10 in the terminal 1 or via a remote navigator 4 located at any point in the internet RI, by implementing sessions between agents. According to the method of the invention, the applications Aₗ through Aₙ do not have to be rewritten and are implemented as is.

In the context of the invention, all or some of the applications Aₗ through Aₙ can comprise applets, which are initially loaded into a nonvolatile memory in the smart card 2 or, contrarily, are loaded by way of the two loading programs OL and IL, whose nature and possible storage links will be described in further detail hereinafter.

In a first aspect of the invention, the webserver function offered by the smart card includes a mechanism similar to the function known as CGI (Common Gateway Interface) implanted in convention webservers.

Before describing an example of architecture according to the invention that makes it possible to achieve a function of this type, even at the level of the smart card, it is useful to recall the principle characteristics of a CGI mode of operation.

CGI is a specification for implementing, from a webserver, applications written for the operating systems known as UNIX (registered trademark), DOS, or Windows (registered trademark). By way of example, for the UNIX operating system, the specification is CGI 1.1, and for the Windows 95 operating system, the specification is CGI 1.3.

Still by way of example, an http request for a URL address, of the following type:

“http://www.host.com/cgi-bin/xxx.cgi” (2),

in which “host” refers to a host system (generally remote), is interpreted by a webserver as the execution of a command script of the CGI type, named “xxx” and present in the “cgi-bin” directory of this host system. Although the name of the directory can a priori be arbitrary, by convention it is the name given to the directory that stores scripts of the CGI type. A script is a set of instructions of the host system operating system, whose final result is transmitted to the web navigator that sent the aforementioned request. Different languages can be used to write the script, such as PERL (registered trademark).

In practical terms, the request is typically posted on an information processing screen as a form comprising an HTML page. The HTML language makes it possible to translate a form into a URL address. The form includes one or more fields which may or may not be obligatory and which are filled by a user, using conventional input means: a keyboard for text, a mouse for putting an X in boxes to be checked, or buttons labelled “radio”, etc. The contents of the form (and as applicable information and instructions said to be “cached”) is sent to the webserver. The HTML code of the page describes the physical structure of the form (context, graphics, color, and any other attribute), and the structure of the data fields to be input (name, length, type of data, etc.).

The transmission can be done by two main types of format. A first format uses the method known as “POST”, and a second uses the method known as “GET”. Information on the format type is present in the code of the form page.

This mechanism cannot, however, be transposed directly to a smart card, even if the smart card has the client/webserver function in accordance with one of the characteristics of the invention.

An example of architecture that makes it possible to activate any application of convention type, via a webserver to the smart card, will now be described in conjunction with FIG. 5.

Among the intelligent agents, in accordance with one of the aspects of the invention, particular intelligent agents are provided, which will hereinafter be called script translator agents, abbreviated STA. The script is then interpreted by one of the intelligent agents.

This translation can be done in various ways:

a) by the web agent 232a1 itself, which in this case is provided with a dual capacity;

b) by a unique script agent capable of translating all the scripts present in the smart card 2a;

c) by a dedicated script agent, which will be called “STAD” hereinafter (one agent per script); or

d) by an APDU agent 201a of the APDU order manager 201a, which in this case is provided with a dual capacity.

The APDU agent 201a is a component of the APDU order manager layer 201a. The latter is a layer capable of

centralizing all the APDU orders sent and/or received by the system, selecting from among applications Aₗ to Aₙ, but also of offering an interface of the intelligent agent type. It is accordingly capable, according to the one of the characteristics of the invention, of communicating with all the intelligent agents (via sessions), whether the agents are located in the housing 6 or the smart card 2a.

In case c) above, a session is opened between the web agent 232a1 and one of the ATSD agents.

FIG. 5 shows an example of an architecture for which the translator agents are of the ATSD type. They are assigned reference symbols STAₗ through STAₙ and are associated with the applications Aₗ through Aₙ. The application selected is assumed to be the application Aᵢ and the session is established between the web agent 232a₁ and the agent STAᵢ.

A script translator agent generates a set of APDU orders. A session is opened between the translator agent, such as the agent STAᵢ and the APDU agent 2101a. The orders are then sent to the APDU agent 2101a. The APDU order manager 201a selects the CGA application Aᵢ and sends it the APDU orders, which orders are translated and accordingly conventional, that it is capable of understanding. This application is then correctly activated without requiring modification or rewriting.

The responses from the application Aᵢ are transmitted to the APDU order manager 201a, to the APDU agent 2010a, and again to the agent STAᵢ (and more generally to the script translator agent).

The various pathways are symbolically represented in FIG. 5 by solid lines connecting function blocks, or dotted lines within these blocks.

The method according to the invention uses the two characteristics that have just been recalled: the function of the smart card as a webserver/client, including a “cgi” function. Loading an applet into the smart card is done in fact via the CGI interface offered by the smart card.

More precisely, in a characteristic of the invention, the portion IL of the loading program located in the smart card 2a comprises a script. For example, this is a script associated with the application Aᵢ in FIG. 5. In a characteristic of the method of the invention, this script is activated by an http request, and the exchanges between the portion OL and the portion IL are done in accordance with the TCP/IP communication protocol. Because of this, the programs IL and OL become a priori compatible. Furthermore, it is no longer necessary to adhere to physical proximity as in the prior art (see FIG. 1). The portion OL can nevertheless be located in the terminal or, preferably, in a remote server (the links between the server and the terminal being made by the TCP/IP protocol), and even, as will be demonstrated, can be stored in the smart card itself. The aforementioned http request is initiated by the portion OL.

It should be noted that the data addressed to the web agent 232a1 are transported in a manner known per se in the form of APDU orders intended for the particular application comprising the “packet multiplexer” 230a. The APDU order manager 201a selects this application in a way quite similar to the other CGA-type applications Aₗ through Aₙ that are present in the smart card 2a. In other words, the packet multiplexer 230a is viewed by the APDU order manager 201a like an ordinary CGA application.

The http request is analyzed by the web agent 232a1, which detects a reference to a particular directory, which by convention will hereinafter be called “cgi-smart” (by analogy with “cgi-bin”), on the one hand, and a particular application, which in the case of the example described is IL. The complete path is thus in this instance “cgi-smart/il”.

In a characteristic of the method of the invention, the above entity “il” designates a particular script associated with what is also a particular application (IL in this case).

A session is opened between the translator agent, for instance the agent STAᵢ, and the APDU agent 2010a. The script translator agent STAᵢ generates a set of APDU orders. The orders are sent to the APDU agent 2010a. The APDU order manager 201a selects the CGA application Aᵢ (for example, the application IL) and sends it the APDU orders, which are translated and hence conventional, that it is capable of understanding. This application is then correctly activated.

The response from the application IL (Aᵢ) is transmitted in the opposite direction to the APDU order manager 201a, to the APDU agent 2010a, and then again to the agent STAᵢ (and more generally to the script translator agent).

The response, comprising a form in HTML language, takes the reverse path, by employing sessions between matched intelligent agents, so as to be retransmitted to the terminal 1, and optionally to a remote server 4 (FIG. 4), via the internet network RI, so that finally it reaches the application OL.

FIG. 6 schematically illustrates the logical architecture that makes it possible to load an applet by the method of the invention. In this diagram, the hardware blocks can be seen comprising the terminal 1, the smart card reader 2 and the smart card 2a, which communicate by employing the standardized protocol ISO 7816 mentioned above and by the exchange of APDU orders, in a manner known per se. The portion OL is put in relation with the portion IL (in the form of a script designated ILs) by exchanges in accordance with the internet protocol TCP/IP, in the manner described above, by employing http server (SC) and CGI functions of the smart card 2a.

It must be understood that although they are shown outside the smart card 2a for the sake of convenience, the blocks SC and ILs comprise different internal modules of the smart card, which have been described in conjunction with FIG. 5.

Conversely, the program OL is not necessarily stored in the terminal 1.

A first example of loading an applet in a smart card 2a will now be described, employing the method known as “GET”.

Let it be assumed that the file 7 for loading the applet has the structure shown in FIG. 7: a header 70, a main body 71 made up of the byte code in JAVA language, and an electronic signature 72. The header represents an identifier of a particular application, generally known as an application identifier or simply AID. The electronic signature 72 is an encrypted word with a public or private key, obtained on the basis of the code 71. The entire file 7 can also be encrypted, for the sake of confidentiality, when sensitive applications are involved. Optionally, one or more additional electronic signatures, not shown, can be provided.

The main steps in the process are schematically illustrated by FIG. 8.

During a first step, the portion OL of the loading program, by a command of the “GET” type, retrieves a loading form from the smart card 2a; the form in HTML will arbitrarily be called “download.html”.

This retrieval is done by consulting a corresponding page whose URL typically takes the following form:

http://127.0.0.1:8080/download.html (3),

in which http://127.0.0.1:8080 is the URL feedback address per se, as defined by relation (1), and “download.html” is the HTML page to be obtained. This request employs a session between intelligent agents as has been described in conjunction with FIGS. 2-4, in a first aspect of the invention. The smart card 2a then plays the role of a webserver.

The smart card 2a sends the form “download.html” in a second step, still by opening sessions between matched intelligent agents, by the method of the invention. The form obtained can be posted on a screen 5 by way of the navigator 10.

To define the concepts, one example of such a form 8 is illustrated in FIG. 9. Aside from various graphic and text zones 80 (title, etc.), the form includes zones for posting the header 70 of the loading file 7, the byte code 71, and the signature 72. The posting zone 71 is of the type called “TEXTAREA” in HTML and has a facility known as “elevator” for scrolling display of long texts. The corresponding information, such as that shown in FIG. 9, is purely arbitrary. Finally, in the known per se, a “send” button 81 is provided, along with a “reset” button 82 for resetting to zero. These buttons are at the disposition of a terminal user (not shown). The send button 81 makes it possible to validate the form and retransmit it to the smart card 2a (as in the caption “submit the loading file” in FIG. 8), and the reset button 82 makes it possible to erase the information posted and to reinitialize the form.

The HTML code necessary for programming such a form is well known per se and is within the competence of one of average skill in the art. There is no need to describe it in detail again here. However, it might be noted that in particular it contains a line of code in HTML that is typically in the following form:

<form action=“http://127.0.01:8080/cgi-smart/loader”> (4),

in which http://127.0.01:8080 is the feedback URL from relation (1), cgi-smart is the aforementioned CGI directory containing the “loader” loading script that has been called “il”, that is, the script associated with the portion IL of the loading program.

If visual display of the form 8 on the screen 5 is not desired (for instance, if there is no human operator), the information can be cached incorporating the following HTML parameter: “TYPE=hidden” in the aforementioned line of code (4).

In a third step, the portion OL sends an http request of the “GET” type to the smart card 2a, still by opening sessions between matched intelligent agents. By calling up the CGI function offered by the smart card 2a, as has been described in conjunction with FIG. 5, the application IL is executed, and the webserver formed by the smart card 2a sends the parameters of the http request to this latter application.

The aforementioned request contains a line of code, typically in the following form:

Smart/loader?AID=xxx*ByteCode=yyy*Signature=zzz (5),

in which: “xxx” is the header 70 (“2001”, in the example of FIG. 9), “yyy” is the byte code 71 (“0123456789ABCDEF”, in the example of FIG. 9), and “zzz” is the electronic signature 71 (“0123456789ABCDEF”, in the example of FIG. 9). The three portions of the loading file are accordingly properly inserted into three fields of the HTML form 8, in concatenated form.

The loading of a particular applet identified by the header 70 takes place at this moment.

Finally, in a fourth step, a return code is transmitted from the portion IL to the portion OL, still employing sessions between matched agents. In general, this involves a simple acknowledgment, or if the operation has not been performed correctly, an error code. In the latter case, steps 1-4 must be repeated.

As an alternative solution, it is possible to use the aforementioned “POST” method. To define the concepts, FIG. 10 illustrates one example of such a form, identified by reference numeral 8′. Various text and graphic zones 80, a header posting zone 70, and a zone for posting the electronic signature 72 can be seen, along with send buttons and reset buttons 81 and 82, respectively. These elements play a role quite similar to the elements with the same reference numerals in FIG. 9, and there is no need to describe them again here. Conversely, the posting zone 71′ does not explicitly display the byte code, but rather a directory or subdirectory in which the code of the applet to be loaded is recorded. In this case, this zone points to a file, arbitrarily called “APPLET.BIN” recorded in a storage unit called “C”, which can be a hard disk located in the terminal 1. An additional navigation or “browse” button 83 makes it possible to browse through the various (sub)directories of this disk and to select a particular file (“APPLET.BIN”).

Like the “GET” method, the “POST” method is well known per se and there is no need to describe it again here. In the specific context of the invention, the applet corresponding to the file “APPLET.BIN” is loaded from the unit “C” in a manner similar to what has been described for the “GET” method.

A second example of loading an applet in the smart card 2a will now be described.

It is equally possible to chain together a plurality of forms upon loading. Instead of a simple status (acknowledgment or error code in the first example described in conjunction with FIG. 8), the return of the portion IL now contains a new form. Hence dynamic sequences of exchange between the portions OL and IL can be achieved.

For example, after analysis of the loading file, the portion IL can ask for an additional authorization (that is, an electronic signature), for instance in a governmental situation. It then sends the OL a form, which can typically have the following HTML structure (6):

<TITLE>Authorization form </TITLE>
<FORM ACTION=”http://@card:8080/cgi-smart/loader”>
<INPUT TYPE=”text” NAME=”GovSignature”
MAXLENGTH=”8”>Signature
</FORM>

in which authorization form, between the HTML flags called “<TITLE>” and <TITLE>, represent the (arbitrary) title of the form; “@card” is the literal translation of the URL wrap-around address of relation (1), and 8080 is the port number; the code line:

<INPUT TYPE=“text”NAME=“GovSignature”MAXLENGTH=“8”>Signature (7)

asks for the input of a variable, arbitrarily called “Signature”, in text mode, with a maximum length of 8 bytes; </FORM> is the HTML flag that indicates the end of the form code.

The complete process then includes two additional steps, with the final step of acknowledgement or an error code, making a total of six steps, as illustrated in FIG. 11.

More generally, the number of round trips can depend on parameters involved in one or the other of the forms exchanged between the smart card and the portion OL of the loading programs.

Up to this point, the location of the portion OL has not been expressly specified. Aside from the face that the method a priori makes OL and IL compatible, it also makes a very great flexibility possible, precisely with regard to this location, it being expected that the portion IL is stored in the smart card 2a, forming one of the applications in this smart card. The method of the invention has the additional advantage in particular of no longer requiring physical proximity between the two portions OL and IL, since they are no longer tributaries of the ISO 7816 communication protocol, since the exchanges between these two software portions use the internet communication protocol TCP/IP.

Also, the portion OL, like the data per se of the applet to be loaded on the smart card 2a, can be stored either locally or at a remote site. In all these cases, however, the exchanges between these two portions, as has just been recalled, a communication protocol TCP/IP, and the loading of an applet is done as has been recalled above, thanks to the webserver/client and CGI functions offered by the smart card 2a.

The main architectures that can be employed in the context of the invention will now be described, in conjunction with FIGS. 12A-12G.

FIG. 12A illustrates a system architecture in which the portion OL is stored locally in the terminal 1. The terminal is connected to a remote server 4 via the internet network RI. The data Da of the applet to be loaded in the smart card 2a are stored in this server 4. An http request enables the transfer to the smart card 2a via the terminal 1 (and a smart card reader, not shown), by using the internet communication protocol TCP/IP.

In the system architecture shown in FIG. 12B, the loading program portion OL and the data Da are stored locally in the terminal 1. The connection of the terminal 1 to the internet network RI is optional. At the very least, an applet need not necessarily be loaded by the steps of the method of the invention. This connection has been shown in dotted lines. Accordingly the terminal can be autonomous.

In the system architecture shown in FIG. 12C, the loading program portion OL and the data Da are stored in a remote server 4. Communications between the server 4 and the smart card 2a via the internet network RI, the terminal 1 and the smart card reader (not shown) are done by way of http requests, using the protocol TCP/IP.

The system architecture shown in FIG. 12D is similar to that of FIG. 12C. The sole difference is that the loading program portion OL is stored in a first remote server 4a, and that the data Da are stored in a second remote server 4b.

In the architecture of FIG. 12E, the loading program portion, here marked OL, is composed of a component of the navigator 10 itself. This advantageously involves an applet integrated with this navigator. The type of input to be used in this case is “file”.

Also advantageously, the data Da of the applet to be loaded in the smart card 2a can be stored on an external data recording medium 9, such as a diskette, as shown in FIG. 12E. Naturally other media can also be used: CD-ROM, magnetic tape, and so forth.

If the aforementioned “post” method is used, it suffices to specify the letter of the storage unit, such as “A” for the diskette 9, a possible path (directory, subdirectories), and the name of the file to be loaded. To define these concepts, the complete path could typically be as follows:

A:/applet.bin (8)

In one of the characteristics of the method of the invention, because of the webserver/client function offered by the smart card 2a, the navigator 10 is at the same time capable, unlike in the prior art, of communicating directly with the latter, as has been demonstrated in conjunction with FIGS. 2-4. The communications take place by opening sessions between matched agents.

The system architecture shown in FIG. 12F is a variant of the architecture of FIG. 12E. In this variant, the loading program portion OL is stored in the smart card 2a itself, in the form of an applet in JAVA language. By an http request, this applet can be loaded dynamically in the terminal 1, via OL″. This loading is done with the aid of requests made by the navigator 10, in the preliminary steps. Once the portion OL has been loaded, the later steps are the same as in the preceding case. The data Da can also be stored in an external medium, such as a diskette 8.

The system architecture in FIG. 12G is a variant of that of FIG. 12F. The sole difference is that the loading program portion OL is stored in a remote server 4, in the form of an applet in JAVA language. As before, by an http request, this applet can be dynamically loaded in the terminal 1, via OL″. This loading is done with the aid of requests made by the navigator 10, in preliminary steps. The other steps are the same as in the preceding case.

It is clear that other architecture variants can be employed without departing from the scope of the invention. In particular, it is possible to load the data Da in the terminal 1 from various sources; for instance, from some other information processing system, connected to the terminal 1 by a local network, or by any other telematic means.

From reading the above description, it can easily be confirmed that the invention indeed attains the objects set for it.

Employing the loading of an applet in a smart card by the CGI interface of a webserver housed in this smart card has the following advantages, in particular:

Using forms in HTML standardizes the loading and makes the loading program portions OL and IL a priori compatible. In fact, as has been demonstrated, it is the portion IL located in the smart card that, in the fields of the form or forms sent, describes the loading parameterization that it is waiting for.

Furthermore, this mechanism of communication between the loading program portions OL and IL makes it possible in a simple way to manage the sequences of dynamic exchanges at the time of the loading.

Using the internet protocols HTTP and TCP/IP for the exchanges between the loading program portions OL and IL makes it possible to separate them physically. All that is necessary in the terminal is routing of packets IP. The loading can then be done in a nonspecialized smart card reader, since the ISO 7816 communication protocol is preserved. The terminal can be a simple standard microcomputer connected to the internet.

In an another advantageous aspect of the method of the invention, the applications stored in the smart card remain standard and accordingly have not been described again here. The smart card and the terminal themselves require only slight modification to be capable of accommodating the method of the invention: These modifications comprise implanting in these two units a communication protocol software layer, which has been called a specific layer and is a software layer that includes intelligent agents.

Alternatively, the loading program portion OL can be loaded dynamically in the terminal, through the card, either from it or from a remote http server.

A simple internet navigator can be used as the loading program OL.

However, it must be clearly understood that the invention is not limited only to the exemplary embodiments described explicitly, especially in conjunction with FIGS. 2-12G.

Furthermore, instead of the HTML language, other similar languages, adapted to internet-type communication protocols, can be used, in particular the language known as XML.

The invention also relates to a method for loading a piece of software into a smart card from a terminal connected to said smart card by way of a smart card reader enabling communications by a first predetermined protocol, the terminal and the smart card including information processing means and information storage means, said loading being effected by the implementation and cooperation of first and second loading programs, said second loading program being stored in the information storage means of said smart card, characterized in that it includes at least the following phases:

a) a first preliminary phase, consisting of implanting, in the information storage means of said smart card (2a), a first piece of software (23a), forming a specific communication protocol layer;

b) a second preliminary phase, consisting of implanting, in the information storage means of said terminal (1), a second piece of software (13), forming a specific communication protocol layer;
that said first and second pieces of software (13, 23a) further include at least one pair of first autonomous software entities (132, 232a), each of said entities (132, 232a) cooperating with one another, thanks to said information processing means of the terminal and the smart card, in such a way as to enable the establishment of a session of bidirectional data exchanges between at least said terminal (1) and said smart card (2a), in such a manner that said smart card (2a) offers the function of a client/webserver;
that it includes a third preliminary phase, consisting of implanting in the information storage means of said smart card (2a) at least one second software entity (STAₗ, STAₙ) capable of interpreting a set of instructions and translating it into a set of orders, in such a way as to cooperate with said second specific piece of software (23a) so that said smart card offers a gateway interface function CGI, said smart card including at least one of said sets of instructions associated with said loading program (IL);
and that it includes at least the following steps:

1) opening a first data exchange session between at least said terminal (1) and said smart card (2a) thanks to said information processing means of the terminal and of the smart card, for the transmission of a request so that said first loading program (OL) will retrieve loading parametrizing data furnished by said second loading program (IL);

2) opening a second data exchange session between said smart card (2a) and at least said terminal (1) thanks to said information processing means of the terminal and of the smart card, to transmit said loading parametrizing data to said first loading program (OL), said parametrizing data including a reference to said instructions that are associated with said second loading program (IL); and

3) opening a second data exchange session between said smart card (2a) and at least said terminal (1) thanks to said information processing means of the terminal and of the smart card, and for submitting a loading file (7) taking said loading parametrizing data into account, said file including data (70, 71, 72) associated with said piece of software to be loaded (Da); interpretation of said set of instructions associated with said second loading program (IL), by implementation of said CGI function, in such a way as to generate a set of orders transmitted to said second loading program (IL) to execute this program (IL) and obtain said unloading of said piece of software (Da).

1-16. (canceled)

17. A method for loading a piece of software into a smart card, through a terminal including a reader for said smart card, by the cooperation of a first loading program implemented external to said smart card and a second loading program stored in said smart card for managing software loading, said smart card storing loading parameter information comprising data needed by said second loading program for loading a piece of software, the method comprising:
establishing a bi-directional communications path between said smart card and said terminal;
wherein the method further comprises the following steps enabled by said bi-directional communications path;
transmitting a request, emitted by said first loading program, for retrieving said loading parameter information needed by said second loading program;
conveying said requested loading parameter information from said smart card to said first loading program, said parameter information including a reference to at least one set of instructions that are associated with said second loading program;
transmitting, from said first loading program to said second loading program, a loading file taking said loading parameter information into account and including data associated with said piece of software to be loaded and further including said reference to at least one set of instructions;
interpreting said at least one set of instructions associated with said second loading program to generate a set of orders to execute said second loading program for loading of said piece of software.

18. The method of claim 17, wherein said bi-directional communications path between said smart card and said terminal is established through bi-directional data exchange sessions opened between matching intelligent agents in said terminal and said smart card, said smart card further comprising at least one software entity enabling the smart card to offer the functions a web client/server and a common gateway interface (CGI) function, said request is an http request, and said loading parameter information being included within a form.

19. The method of claim 17, wherein said method includes storing said first loading program in said terminal.

20. The method of claim 17, wherein said terminal is connected to a communication network and wherein said method includes storing said first loading program at a remote server connected to said network.

21. A method for loading a piece of software into a smart card, using a terminal including a reader for said smart card and a first loading program stored external to said smart card, the method comprising:
establishing a bi-directional communications path between said smart card and said terminal, where said smart has stored therein a second loading program and loading parametrizing data for use by said second loading program for loading the piece of software;
wherein the method further comprises the following steps enabled by said bi-directional communications path;
transmitting, from said first loading program, a request for said loading parametrizing data needed by said second loading program;
sending said requested loading parametrizing data from said smart card to said first loading program, said loading parametrizing data including a reference to at least one set of instructions associated with said second loading program;
transmitting, from said first loading program to said second loading program, a loading file using said loading parametrizing data and including data associated with said piece of software to be loaded and further including said reference to said at least one set of instructions; and
interpreting said at least one set of instructions to generate a set of orders to execute said second loading program to load said piece of software.

22. The method of claim 21, wherein said bi-directional communications path between said smart card and said terminal is established through bi-directional data exchange sessions opened between matching intelligent agents in said terminal and said smart card, said smart card further comprising at least one software entity enabling the smart card to offer the functions of a web client/server and a common gateway interface (CGI) function, and said loading parametrizing data is included within a form.

23. The method of claim 21, wherein said method includes storing said first loading program in said terminal.

24. The method of claim 21, wherein said first loading program is stored at a remote server connected to said terminal.

25. The method of claim 24, wherein said remote server is connected to said terminal by a communication network.

26. The method of claim 21, wherein said request for retrieving said loading parameter information is an http request.

27. The method of claim 21, wherein said loading parametrizing data comprises an html form.

28. A system for loading a piece of software into a smart card, using a terminal including a reader for said smart card and a first loading program stored external to said smart card, the system comprising:
means for establishing a bi-directional communications path between said smart card and said terminal, where said smart has stored therein a second loading program and loading parametrizing data for use by said second loading program for loading the piece of software;
means for transmitting via said bi-directional communications path, from said first loading program, a request for said loading parametrizing data needed by said second loading program;
means for sending via said bi-directional communications path said requested loading parametrizing data from said smart card to said first loading program, said loading parametrizing data including a reference to at least one set of instructions associated with said second loading program;
means for transmitting via said bi-directional communications path, from said first loading program to said second loading program, a loading file using said loading parametrizing data and including data associated with said piece of software to be loaded and further including said reference to said at least one set of instructions; and
means for interpreting via said bi-directional communications path said at least one set of instructions to generate a set of orders to execute said second loading program to load said piece of software.

29. The system of claim 28, wherein said bi-directional communications path between said smart card and said terminal is established through bi-directional data exchange sessions opened between matching intelligent agents in said terminal and said smart card, said smart card further comprising at least one software entity enabling the smart card to offer the functions of a web client/server and a common gateway interface (CGI) function, and said loading parametrizing data is included within a form.

30. The system of claim 28, wherein said method includes storing said first loading program in said terminal.

31. The system of claim 28, wherein said first loading program is stored at a remote server connected to said terminal.

32. The system of claim 31, wherein said remote server is connected to said terminal by a communication network.

33. The system of claim 28, wherein said request for retrieving said loading parameter information is an http request.

34. The system of claim 28, wherein said loading parametrizing data comprises an html form.
